(19) United States
(12) Patent Application Publication
(10) Pub. No.: US 2025/0134015 A1
(43) Pub. Date: May 1, 2025

(54) Plant Growth System

(71) Applicant: ROCKWOOL A/S, Hedehusene (DK)

(72) Inventors: Linda Albertina Wilhelmina DE VRIES, Hedehusene (DK); Hanaa AL DOUGHRY, Hedehusene (DK)

(21) Appl. No.: 18/837,270

(22) PCT Filed: Feb. 15, 2023
(86) PCT No.: PCT/EP2023/053814

§ 371 Date: Aug. 9, 2024

(30) Foreign Application Priority Data
Feb. 15, 2022 (EP) 22156867.8

(51) Int. Cl. A01G 27/02; A01G 24/18; A01G 24/44

(52) U.S. Cl. CPC A01G 27/02; A01G 24/18; A01G 24/44

(57) ABSTRACT

The disclosure relates to a plant growth system (1) comprising: ·—a water impermeable container (2) having a base and side walls, wherein the water impermeable container comprises within: ·(i) a layer of buffer material (3) for absorbing storm water and; ·(ii) a first void space (4); wherein the layer of buffer material has a first side surface, a second side surface and a bottom surface, wherein the bottom surface of the layer of buffer material is in direct contact with the base of the water impermeable container and wherein the buffer material comprises man-made vitreous fibres (MMVF) bonded with a cured binder composition wherein the first void space is in fluid communication with the first side surface of the layer of buffer material; ·—an inlet (5) for water to enter the first void space of the water impermeable container; ·—a plant growth substrate layer (6), positioned above the layer of buffer material and in fluid communication with the layer of buffer material.

### FIELD OF THE INVENTION

The present invention relates to a plant growth system comprising a layer of buffer material and a plant growth layer.

### BACKGROUND OF THE INVENTION

Urban green infrastructure, such as parks and other green spaces, provides important ecological, social and economic benefits. In order to maintain such spaces, it is essential to provide irrigation to the plants at various points throughout the year. This can lead to clean, drinkable water being used for irrigation during periods of low rain or drought, such as in summer months. For example, one square meter of green surface requires on average about 70 litres of water per week. During the dry season, it is necessary for water to be actively provided to green spaces.

There is an ongoing requirement to reduce the amount of water usage and wastage, in particular in urban areas. However, there is also a strong need to increase and improve urban green infrastructure. For example, there is a desire to improve the appearance of urban green areas by extending the flowering period. In addition, there is a desire to increase biodiversity, for example, by using plants that require more water on average. Urban green areas are also desirable as they reduce heat stress by creating more greenery in urban areas which cools down the immediate environment.

Having more urban green areas inevitably requires the use of more water for irrigation during the dry season. Such irrigation involves labour and costs, as individuals must employed to provide water directly to the green spaces or to provide maintenance of any irrigation system in place.

At the same time, during periods of high precipitation, urban areas may have excess surface water. For example, standard storm water drainage systems in urban areas may become overwhelmed leading to flooding and waterlogging of the ground. In order to combat this, water storage areas, such as water infiltration systems, are installed. These are designed to store large volumes of excess water. The water can subsequently be transported to water collection points and/or stored and then allowed to dissipate into the surrounding ground once it is dry enough. Such water infiltration systems have the aim of preventing flooding in urban areas.

WO 2013/072082 A1 discloses a water drain reservoir comprising a coherent man-made vitreous fibres (MMVF) substrate and a conduit having two open ends.

WO 2020/069134 A1 discloses a stormwater planter system containing plant material comprising a container fabricated of concrete, metal, plastic, or the like, that captures surface rainwater runoff or roof rainwater runoff whereby debris, sands, sediment, pollutants within the water are separated, treated and/or attenuated via multiple processes within a predetermined organic and/or non-organic aggregate material layer. However, this system has the disadvantage that the amount of water is not determined by the watering need of the plants, but by the presence of water in the container. Thereby, the substrate will be oversaturated at times of water availability and dry out quickly during drought periods.

KR102097635 discloses a rainwater storage device comprising a water retaining means configured to let rainwater flow thereinto and to temporarily store and then to discharge the rainwater; a filtering means manufactured by mineral wool to let the rainwater of the water retaining means flow thereinto and to filter contaminants; a storage tank formed on a position separated from the filtering means and associated with a penetration portion formed on a lower portion of the filtering means to store rainwater from which foreign substances are removed; and a pump installed inside the storage tank to discharge stored rainwater to an outside of the storage tan, and accordingly, can reuse rainwater and can preserve underground water by supplying a portion of rainwater to the ground, and can maintain a typical strength of the ground and an ecosystem in the ground. This system is not concerned with storing rainwater for the use of plants above, but rather focusses on filtering rainwater which is then transported away via a pipe, or allowed to infiltrate into the ground below.

It would be desirable for urban areas to balance water usage throughout the year i.e. to avoid excess flooding in periods of high precipitation and to avoid the use of clean water for irrigation of plants during periods of drought. It would be desirable for any irrigation to be provided passively, without the need for labour. It would be desirable to keep the substrate that plants grow in at a constant moisture level without the need for active watering. In particular, the plants would benefit from the moisture level being homogeneous across the entire substrate. It would also be desirable to ensure that particulate matter and other detritus is removed from storm water prior to its use in irrigation or before it is passed into a municipal drainage system.

### SUMMARY OF THE INVENTION

The present inventors have provided a plant growth system which comprises a layer of buffer material and a plant growth layer. It has the dual benefit of absorbing excess storm water, thus preventing surface flooding, and providing this water to plants when needed, thus reducing water consumption. It also filters the storm water, to remove particulate matter and other detritus and impurities, prior to its use in irrigation or before it is passed into a municipal drainage system. The capillary action of the man-made vitreous fibre (MMVF) buffer layer, in combination with the buffer layer being positioned on a water impermeable surface, means that water moves upwards to the plant growth substrate layer above, and not into the surrounding ground as with a traditional irrigation system. The inventors discovered that the use of a void space, in fluid communication with the inlet and the side of the layer of buffer material, ensures that the layer of buffer material is wetted in the optimal manner: the water is absorbed quickly and evenly over the layer of buffer material. Further, the presence of a second void space and outlet, configured so that water entering the first void space through the inlet must pass through the layer of buffer material before it enters the second void space and then exit the system through the outlet, means that water provide to the plant growth substrate layer and water that exits the system through the outlet is filtered and free from particulate matter and other detritus and impurities.

This system provides better water balance for urban areas: precipitation water is absorbed and stored in the layer of buffer material during wet periods, and this water is used for plants during the growing season.

This allows for more efficient maintenance of green spaces; it reduces the number of regular irrigation moments (thus reducing labour and water consumption), and also makes greenery less vulnerable during drought periods.

This system has the further benefit of re-using rainwater by storing rainwater and making it available to plants during the growing season and during periods of drought.

Furthermore, this is a passive irrigation system: it retains storm water in the layer of buffer material, making it freely available to the plant growth layer above, via capillary action, when needed.

Finally, this system is easy to install and is very flexible as the MMVF buffer layer can be cut on site to fit any desired shape. This simplifies the installation process which minimises disruption to the green space. The system is also easy to maintain and clean, as the MMVF buffer layer may be accessed via the inlet and first void space that captures any particulate matter and other detritus and impurities. For additional protection against particulate matter and other detritus and impurities, a trap may be included in the system, such as a sand trap at the bottom of a well, to help prevent particulate matter and other detritus and impurities entering the first void space.

In a first aspect of the invention, there is provided a plant growth system comprising:
a water impermeable container having a base and side walls, wherein the water impermeable container comprises within:
   (i) a layer of buffer material for absorbing storm water and;
   (ii) a first void space;
   wherein the layer of buffer material has a first side surface, a second side surface and a bottom surface, wherein the bottom surface of the layer of buffer material is in direct contact with the base of the water impermeable container and wherein the buffer material comprises man-made vitreous fibres (MMVF) bonded with a cured binder composition wherein the first void space is in fluid communication with the first side surface of the layer of buffer material;
an inlet for water to enter the first void space of the water impermeable container;
a plant growth substrate layer, positioned above the layer of buffer material and in fluid communication with the layer of buffer material.

It is preferable that the plant growth system comprises a second void space (8) in fluid communication with the second side surface of the layer of buffer material and an outlet (10) for excess water to leave the layer of buffer material, wherein the first void space and second void space are configured so that water entering the first void space through the inlet must pass through the layer of buffer material before it is able to enter the second void space, and exit vis the outlet.

In a second aspect of the invention, there is provided a method of irrigating a plant, comprising the steps of:
providing a plant growth system as described herein;
positioning at least one plant in the plant growth substrate layer;
allowing storm water to enter the layer of buffer material via the inlet and first void space;
allowing the storm water to pass into the plant growth substrate layer by capillary action.

In this aspect, the plant growth system is provided in such a way that storm water entering the layer of buffer material via the inlet and first void space is able to pass into the plant growth substrate layer by capillary action.

According to the third aspect of the invention, there is provided a method of installing a plant growth system, comprising positioning at least one plant growth system as described herein in the ground.

### BRIEF DESCRIPTION OF THE FIGURES

FIG. 1 shows a plant growth system according to an embodiment of the invention.

FIG. 2 shows a plant growth system according to an embodiment of the invention.

FIG. 3 shows the results of a calculation of yearly water usage.

FIG. 4 shows the results of a calculation of yearly water usage.

FIG. 5 shows the results of a water absorption test.

FIG. 6 shows the results of a water absorption test.

FIG. 7 shows the results of a maximum buffering capacity test.

FIG. 8 shows the results of a maximum buffering capacity test.

FIG. 9 shows the results of a water release test.

FIG. 10 shows the results of a water release test.

FIG. 11 shows a SEM image.

FIG. 12 shows a SEM image.

FIG. 13 shows the results of a substrate moisture level test.

FIG. 14 shows the results of a substrate moisture level test.

### DETAILED DESCRIPTION

The invention relates to a plant growth system comprising:
a water impermeable container having a base and side walls, wherein the water impermeable container comprises within:
(i) a layer of buffer material for absorbing storm water and;
(ii) a first void space;
   wherein the layer of buffer material has a first side surface, a second side surface and a bottom surface, wherein the bottom surface of the layer of buffer material is in direct contact with the base of the water impermeable container and wherein the buffer material comprises man-made vitreous fibres (MMVF) bonded with a cured binder composition;
   wherein the first void space is in fluid communication with the first side surface of the layer of buffer material;
an inlet for water to enter the void space of the water impermeable container;
a plant growth substrate layer, positioned above the layer of buffer material and in fluid communication with the layer of buffer material.

A single layer of buffer material for absorbing storm water is used in the present system. This is opposed to a number of (i.e. two or more) separate columns of MMVF being present, which would lead to a lack on homogeneity in the moisture content in the plant growth substrate layer, and also the storm water exiting the system would not be filtered to remove particulate matter and other detritus and impurities.

The term “plant growth system” has its normal meaning in the art. It relates to a system that is suitable for growing plants, for any desired length of time.

The plant growth system comprises a water impermeable container having a base and side walls. By this it is meant that the base is a closed surface and forms a container with the side walls. There may be three or four side walls. The base and side walls thus create an interior volume which is open at the top. The container may also be called a receptacle, a basin, a well, a trough or the like. The term “water impermeable” has its usual meaning, that is, the container acts as a barrier preventing infiltration of water in or out of the container.

The water impermeable container may be any suitable shape and size. Preferably, the height of the impermeable container is at least the same as the height of the buffer material. The height of the impermeable container may also be 5 to 15 cm taller than that of the buffer material.

The water impermeable container may be formed of any suitable material. Preferably, the water impermeable container is formed of foil, hydrated clay, plastic, corrugated plastic, high density mineral wool or a combination thereof.

The water impermeable container functions as a capillary break for the layer of buffer material. Essentially, the water impermeable container allows water to move up through the buffer material, against gravity. This is called capillary action.

Capillary action is a phenomenon in which a liquid can move vertically, against the forces of gravity, in small spaces between materials.

In the traditional sense, a capillary is a tube with a very small diameter. The interface between the wall of the tube and the liquid gives a force upward. The smaller the diameter of the tube, the higher the ratio of interface area to liquid volume. This means that the liquid will rise inside a tube. The smaller the diameter of the tube, the higher the liquid can rise. This is called the capillary rise.

This phenomenon of capillary action and capillary rise is seen in the present invention, for the buffer layer comprising MMVF when in the plant growth system of the invention. Although MMVF products do not contain tubes as such, capillary rise occurs around the fibres themselves. The fibre diameter of man-made vitreous fibres is very small which causes a water layer around the fibre. The weight of this water layer is balanced with the interface layer between the water and the fibre and capillary rise within the MMVF substrate occurs.

Therefore, MMVF, by the nature of the material itself, shows capillary action meaning that water can rise vertically against gravity. However, without a water impermeable layer under the layer of buffer material, the capillary action is likely to be insufficient to adequately provide water to the plant growth substrate layer.

The water impermeable container comprises within a layer of buffer material for absorbing storm water. By this it is meant that the layer of buffer material is positioned within the internal volume of the container, created by the base and side walls.

The layer of buffer material has a first side surface, a second side surface and a bottom surface. The layer of buffer material also has a top surface. The layer of buffer material is in direct contact with the base of the water impermeable container. By this it is meant that the bottom surface of the layer of buffer material is in direct contact with the base of the container. This arrangement means the water impermeable container functions as a capillary break, and thus allows capillary action of water within the buffer material to occur. Preferably the entire length of the bottom surface of the layer of buffer material is in direct contact with the base of the container.

A key feature of the plant growth system is that it may be used to filter, or remove, particulate matter and other detritus and impurities from water that enters the system through the inlet. This means that water is cleaned prior to it entering the plant growth substrate layer or exiting the system through the outlet. This is beneficial as many countries require storm water and other grey water from urban and other areas to be cleaned prior to its introduction into waterways or municipal drainage systems. The present system achieves this by using a second void space (8) in fluid communication with the second side surface of the layer of buffer material and an outlet (10) for excess water to leave the layer of buffer material. The first void space and second void space are configured so that water entering the first void space through the inlet must pass through the layer of buffer material before it is able to enter the second void space. With this configuration, particulate matter and other detritus and impurities may be retained on the first side surface of the layer of buffer material. Cleaning of the layer of buffer material is therefore limited to only that one surface.

Particulate matter means any dirt, detritus or other solid material that may be carried by storm water into the plant growth system.

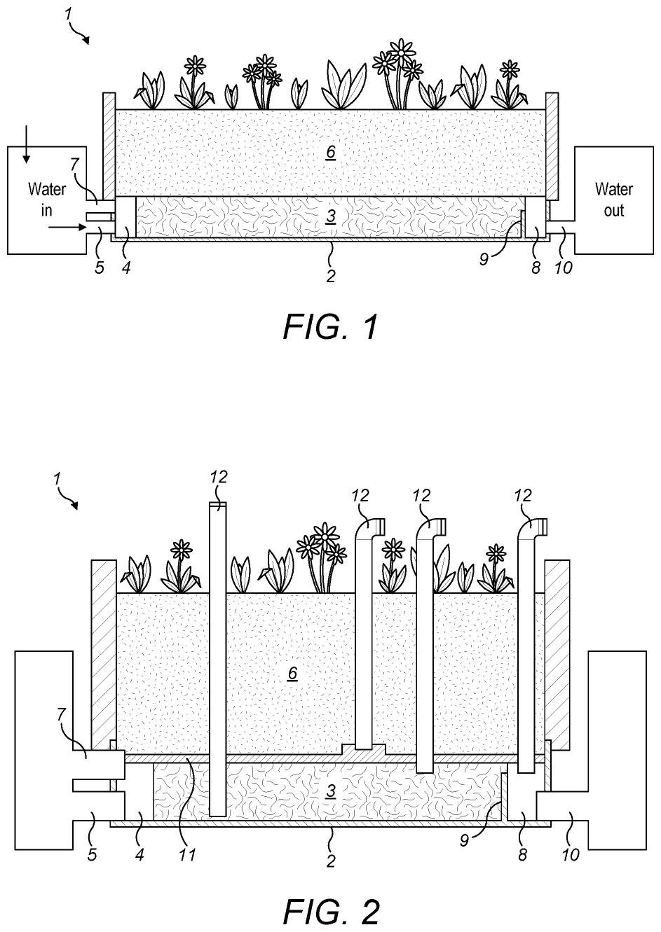

It is preferable that the layer of buffer material occupies a substantial amount of the volume in the water impermeable container under the plant growth substrate layer. It will be understood that the volume referred to in the water impermeable container under the plant growth substrate layer includes the layer of buffer material (3), first void space (4), and second void space (8), as noted in FIG. 1. This may also be described as the volume between the base of the water impermeable container and the plant growth substrate layer. In this regard, it is preferable that the layer of buffer material occupies at least 50%, such as at least 70%, more preferable at least 90%, most preferably at least 95%, of the volume in the water impermeable container under the plant growth substrate layer. This is to maximise water retention within the water impermeable container, as the water will be absorbed by the layer of buffer material. This is particularly important when the system is used for storm water, as the system may have to absorb a large amount of water in a short period of time.

The buffer material comprises man-made vitreous fibres (MMVF) bonded with a cured binder composition.

The man-made vitreous fibres (MMVF) can be glass fibres, ceramic fibres, basalt fibres, slag wool, stone wool and others, but are usually stone wool fibres. Stone wool generally has a content of iron oxide at least 3% and content of alkaline earth metals (calcium oxide and magnesium oxide) from 10 to 40%, along with the other usual oxide constituents of MMVF (e.g. silica and alumina). The stone wool generally comprises alkali metals (sodium oxide and potassium oxide), in the range of 1% to 20%. The stone wool may also include titania and other minor oxides.

Stone fibres commonly comprise the following oxides, in percent by weight:
SiO₂: 30 to 51
Al₂O₃: 12 to 30
CaO: 8 to 30
MgO: 2 to 25
FeO (including Fe₂O₃): 2 to 15
Na₂O+K₂O: not more than 10
CaO+MgO: 10 to 30

In preferred embodiments the MMVF have the following levels of elements, calculated as oxides in wt %:
SiO₂: at least 30, 32, 35 or 37; not more than 51, 48, 45 or 43
Al₂O₃: at least 12, 16 or 17; not more than 30, 27 or 25
CaO: at least 8 or 10; not more than 30, 25 or 20
MgO: at least 2 or 5; not more than 25, 20 or 15
FeO (including Fe₂O₃): at least 4 or 5; not more than 15, 12 or 10
FeO+MgO: at least 10, 12 or 15; not more than 30, 25 or 20
Na₂O+K₂O: zero or at least 1; not more than 10
CaO+MgO: at least 10 or 15; not more than 30 or 25
TiO2: zero or at least 1; not more than 6, 4 or 2
TiO₂+FeO: at least 4 or 6; not more than 18 or 12
B₂O₃: zero or at least 1; not more than 5 or 3
P₂O₅: zero or at least 1; not more than 8 or 5
Others: zero or at least 1; not more than 8 or 5

The MMVF made by the method of the invention preferably have the composition in wt %:
SiO₂ 35 to 50
Al₂O₃ 12 to 30
TiO₂ up to 2
Fe₂O₃ 3 to 12
CaO 5 to 30
MgO up to 15
Na₂O 0 to 15
K₂O 0 to 15
P₂O₅ up to 3
MnO up to 3
B₂O₃ up to 3

Another preferred composition for the MMVF is as follows in wt %:
SiO₂ 39-55% preferably 39-52%
Al₂O₃ 16-27% preferably 16-26%
CaO 6-20% preferably 8-18%
MgO 1-5% preferably 1-4.9%
Na₂O 0-15% preferably 2-12%
K₂O 0-15% preferably 2-12%
R₂O (Na₂O+K₂O) 10-14.7% preferably 10-13.5%
P₂O₅ 0-3% preferably 0-2%
Fe₂O₃ (iron total) 3-15% preferably 3.2-8%
B₂O₃ 0-2% preferably 0-1%
TiO₂ 0-2% preferably 0.4-1%
Others 0-2.0%

Glass fibres commonly comprise the following oxides, in percent by weight:
SiO₂: 50 to 70
Al₂O₃: 10 to 30
CaO: not more than 27
MgO: not more than 12
Glass fibres can also contain the following oxides, in percent by weight:
Na₂O+K₂O: 8 to 18, in particular Na₂O+K₂O greater than CaO+MgO
B₂O₃: 3 to 12

Some glass fibre compositions can contain Al₂O₃: less than 2%.

In one embodiment, the buffer material comprises coherent man-made vitreous fibres (MMVF) bonded with a cured binder composition. By “coherent” it is meant that the buffer material is in the form of a coherent mass of MMVF i.e. a MMVF substrate or slab. That is, the buffer material is preferably a coherent matrix of MMVF fibres bonded with a cured binder composition, which has been produced as such, or has been formed, for example, by granulating a slab of MMVF and consolidating the granulated material. A coherent substrate or slab is a single, unified substrate of MMVF.

In another embodiment, the buffer material comprises granulate man-made vitreous fibres (MMVF) bonded with a cured binder composition. By this, it is meant that the MMVF is fragmented and loose. In this embodiment, the buffer layer is made by packing the loose, granulate MMVF into the water impermeable container. A benefit of this is that the granulate MMVF can be used to fill any sized shape without the need to cut material on site i.e. installation is faster and simpler.

The granulate MMVF bonded with a cured binder composition may be made by any known method. Preferably, it is made by recycling used hydrophilic MMVF substrates, especially from horticultural use (i.e. plant growth substrates made from MMVF). This is environmentally advantageous. The used plant growth substrates may be cleaned and then cut into fragments prior to use.

When the buffer material comprises granulate MMVF bonded with a cured binder composition, the first side surface and the second side surface of the layer of buffer material are preferably formed with the support of a water permeable wall (i.e. an element for mechanical stability). For example, this may be a grid or crate. This ensures that the layer of buffer material is separate to, but in fluid communication with, the first void space and the optional second void space.

In another embodiment, the buffer material comprises coherent MMVF bonded with a cured binder composition and granulate MMVF bonded with a cured binder composition. For example, the buffer layer may comprise a slab of MMVF bonded with a cured binder composition and granulate MMVF bonded with a cured binder composition. In this embodiment, preferably the slab of MMVF is positioned immediately adjacent the first void space, and the granulate MMVF is positioned in the remaining layer of buffer material. This ensures that the granulate material does not move into the first void space.

Irrespective of the form of the layer of buffer material, it is preferable that only the first side surface of the buffer material is in fluid communication with the first void space. This means that no other sides of the buffer material are in communication with the first void space. As mentioned, this means particulate matter may only be deposited on a single face of the buffer material, which is beneficial for cleaning as only one surface of the buffer material may need to be cleaned. Having a single coherent slab of MMVF in fluid communication with the first void space means removal of the MMVF slab for cleaning is easier, for example to remove the build-up of particulate matter in the first void space.

Also irrespective of the form of the layer of buffer material, the layer of buffer material may comprise a removable MMVF filter that forms its first side surface. This means cleaning the layer of buffer material is even easier as the filter may be removed and replaced via the inlet. The removable MMVF filter may alternatively be located in the inlet to prevent particulate matter and other detritus and impurities entering the first void space. For additional protection, a removable MMVF filter may form the first side surface of the layer of buffer material and another removable MMVF filter may located in the inlet.

When the plant growth system comprises a second void space, preferably the buffer material comprises at least two slabs of MMVF bonded with a cured binder composition and granulate MMVF bonded with a cured binder composition. Preferably, one slab is positioned immediately adjacent the first void space and the second slab is positioned immediately adjacent the second void space. The granulate MMVF is then positioned in the remaining area of layer of buffer material i.e. in between the two slabs of MMVF. This ensures that the granulate material does not move into the first and second void spaces.

Preferably, at least 50%, more preferably at least 70%, even more preferably at least 90%, most preferably at least 95%, of the area of the bottom surface of the plant growth substrate layer is in fluid communication with the layer of buffer material. Increasing the area in which water may pass from the layer of buffer material into the plant growth substrate layer is beneficial because it allows water to be evenly distributed throughout the plant growth substrate layer. Thus, water is distributed to the plants in the plant growth substrate layer more evenly.

In the above embodiment, where the buffer material comprises coherent and granulate MMVF bonded with a cured binder composition, preferably the slabs positioned immediately adjacent the first and/or second void space have a predominant fibre orientation of horizontal with respect to the base of the water impermeable container. This encourages the flow of water towards the central area of the layer of buffer material.

Preferably the layer of buffer material comprises MMVF having a geometric fibre diameter of 1.5 to 10 microns, preferably 2 to 8 microns, more preferably 2 to 5 microns. The inventors found that this range of geometric fibre diameter positively affects capillary action thus aiding the path of water up through the buffer material, to the plant growth substrate layer above. The inventors have discovered that, in general, the smaller the geometric fibre diameter, the higher the capillary rise.

Preferably the layer of buffer material has a density in the range of 70 to 200 kg/m³ preferably 100 to 160 kg/m³. This density range is beneficial because it positively affects capillary action thus aiding the path of water up through the buffer material, to the plant growth substrate layer above. In general, the inventors have found that a higher density of MMVF means a higher capillary rise due to there being more fibres per volume.

Preferably the layer of buffer material has a height in the range of 5 cm to 50 cm, preferably 10 cm to 20 cm. The inventors have discovered that this range is beneficial because it finds a balance between maximising the height (to maximise the volume of water that can be stored) and ensuring that strong capillary action is obtained so that the water reaches to the plant layer above.

The binder in the buffer material can be an organic hydrophobic binder, and in particular it can be a conventional heat-curable (thermosetting), binder of the type which has been used for many years in MMVF substrates (and other MMVF-based products). This has the advantage of convenience and economy. Thus, the binder is preferably a phenol formaldehyde resin or urea formaldehyde resin, in particular phenol urea formaldehyde (PUF) resin.

The binder may be a formaldehyde-free binder, for example it may comprise a sugar, a furan, a lignin, a hydrocolloid, a carbohydrate, an amine, sulfamic acid or the like as a main component. The formaldehyde-free binder may be as described in any of the following publications: WO2004/007615, WO97/07664, WO07129202, WO2017/114724, WO2017/114723 or WO2020/070337.

Preferably, the buffer material has a binder content in the range of 1% to 10%, preferably 2% to 5%. This ensures a balance between strength and production cost.

Preferably, the layer of buffer material is hydrophilic that is, it does not repel water. Hydrophilic has its normal meaning in the art. An advantage of the buffer being hydrophilic is improves capillary rise in the buffer material, which moves the water up through the material to the plant growth substrate layer above.

The hydrophilicity of the layer of buffer material may be defined in terms of the contact angle with water. Preferably the layer of buffer material has a contact angle with water of less than 90°. The contact angle is measured by a sessile drop measurement method. Any sessile drop method can be used, for example with a contact angle goniometer. In practice, a droplet is placed on the solid surface and an image of the drop is recorded in time. The static contact angle is then defined by fitting Young-Laplace equation around the droplet. The contact angle is given by the angle between the calculated drop shape function and the sample surface, the projection of which in the drop image is referred to as the baseline. The equilibrium contact angles are used for further evaluation and calculation of the surface free energy using the Owens, Wendt, Rabel and Kaeble method. The method for calculating the contact angle between material and water is well-known to the skilled person.

The hydrophilicity of the layer of buffer material may be defined by the hydraulic conductivity. Preferably the layer of buffer material has a hydraulic conductivity of 5 m/day to 300 m/day, preferably 50 m/day to 200 m/day. Hydraulic conductivity is measured in accordance with ISO 17312:2005. The advantage of this is that it ensures that the water can dissipate throughout the buffer fast enough during a rain event.

The hydrophilicity of a sample of MMVF substrate can be measured by determining the sinking time of a sample. A sample of MMVF substrate having dimensions of 100×100×15 mm to 100×100×100 mm is required for determining the sinking time. A container with a minimum size of 200×200×200 mm is filled with water. The sinking time is the time from when the sample first contacts the water surface to the time when the test specimen is completely submerged. The sample is placed in contact with the water in such a way that a cross-section of 100×100 mm first touches the water. The sample will then need to sink a distance of just over the height of the sample in order to be completely submerged. The faster the sample sinks, the more hydrophilic the sample is. The MMVF substrate is considered hydrophilic if the sinking time is less than 240 s. Preferably the sinking time is less than 100 s, more preferably less than 60 s, most preferably 50 s. In practice, the MMVF substrate may have a sinking time of 50 s or less.

In one aspect, the predominant fibre orientation of the MMVF in the layer of buffer material is vertical with respect to the base of the water impermeable container. By this, it is meant that the fibres are arranged substantially in the vertical direction. The inventors have discovered that this fibre orientation increases the capillary rise of water in the MMVF buffer layer. In one aspect, the predominant fibre orientation of the MMVF in the layer of buffer material may be horizontal with respect to the base of the water impermeable container. This is for ease of installation. The inventors have discovered that a sufficient capillary rise is achieved even when the predominant fibre orientation is horizontal.

Preferably, the layer of buffer material is free from oil or substantially free from oil. Preferably, the layer of buffer material is substantially free from oil. By this, it is meant that the layer of buffer material comprises only trace amounts of oil, for example less than 0.1 wt % of oil. Most preferably the layer of buffer material is free from oil. By this it is meant that the layer of buffer material has 0 wt % of oil. Oil is typically added to MMVF substrates which are to be used for purposes such as sound, insulation, thermal insulation and fire protection. However, the layer of buffer material is sufficiently hydrophilic to absorb and store water when it is free from oil or substantially free from oil. In this embodiment, the binder composition may be hydrophilic or hydrophobic, as discussed above. Preferably, when the binder composition is hydrophobic, the layer of buffer material is free from or substantially free from oil.

Preferably, the layer of buffer material has a water holding capacity of at least 80% of the volume, preferably 80-99%, most preferably 85-95%. The greater the water holding capacity, the more water that can be stored for a given volume. The water holding capacity of the buffer material is high due to the open pore structure of MMVF.

Preferably the buffering capacity of the buffer material, that is the difference between the maximum amount of water that can be held, and the amount of water that is retained when the buffer material gives off water is at least 60% vol, preferably at least 70% vol, preferably at least 80% vol. The buffering capacity may be 60 to 90% vol, such as 60 to 85% vol. The advantage of such a high buffering capacity is that the buffer material can buffer more water for a given volume, that is buffer material can store a high volume of water when it rains, and release a high volume of water as to the plant growth substrate layer.

The water holding capacity, the amount of water retained and the buffering capacity of the buffer material can be calculated from dry bulk density, air volume, water volume, shrinkage value and total pore space measured in accordance with EN 13041-1999.

The water impermeable container comprises within a first void space. By this, it is meant that a first void space is positioned within the internal volume of the water impermeable container, created by the base and side walls.

The first void space is in fluid communication with the first side surface of the layer of buffer material. By this, it is meant that fluid, such as storm water, present in the first void space can move into the layer of buffer material through the first side surface of the buffer material.

The first void space is an empty space comprised within the internal volume of the water-impermeable container. Preferably, the first void space is formed between a side wall of the water impermeable container and the first side surface of the layer of buffer material. The base of the water impermeable container forms the base of the first void space. The first void space is essentially a gap between a side wall of the water impermeable container and the first side surface of the layer of buffer material.

The first void space provides means for storm water (which enters through an inlet into the first void space) to pass into the buffer material in an optimal way. Crucially, the present inventors have discovered that the buffer material of the present invention has higher buffering capacity i.e. can hold more water when the water enters the buffer material through a side surface. This has been shown in the examples of the invention. The first void space plays an essential role in this technical effect by ensuring the storm water enters the buffer material quickly, and in the optimal location (at the side). The benefit of a void space on the side of the buffer material is that the water level can rise to the top and pushes all the air to the direction of the other side. It creates a large contact area. Without the void space, the rainwater would need to enter the buffer material at the speed it comes in with the rain. This will often lead to local supersaturation of the MMVF, meaning that not all water will be absorbed. The excess water will be lost to the system and thus does not make optimal use of the available rainwater.

The first void space may comprise an open structure, such as a crate, to maintain the void space. Preferably, the first void space comprises an open plastic crate. The void space may also comprise gravel—this naturally comprise gaps between the gravel particles, which acts as the void space. The open structure may also be made from plastic, concrete or steel. The purpose of the open structure is to ensure that the void space between the side wall of the water impermeable container and the first side surface of the layer of buffer material is maintained during use of the plant growth system i.e. to sustain the static load from above and to prevent the layer of buffer material from moving during use such that the void space is reduced.

Preferably, the first void space is in fluid communication with at least 25% of the surface area of the first side surface of the layer of buffer material, preferably at least 30%, more preferably at least 40%, more preferably at least 50%, more preferably at least 60%, more preferably at least 70%, more preferably at least 80%, most preferably at least 90% of the surface area of the first side surface of the layer of buffer material. The benefit of this is that the buffer layer can absorb water very quickly and to the optimal extent i.e. high water retention and buffering capacity is achieved.

The plant growth system according to the present invention may comprise elements for mechanical stability. These are elements that improve the overall mechanical stability of the system, such as pole, crates or grids. Preferably, the system comprises elements that improve the mechanical stability of the layer of buffer material. These elements may include poles, crates or grids. As discussed above, when the layer of buffer material comprises granulate MMVF, preferably the first side surface and second side surface of the buffer layer is formed of a water permeable element for mechanical stability. This may be a grid or crate.

The plant growth system according to the present invention comprises an inlet for water to enter the first void space. The inlet is preferably the principle route through which storm water can enter the water impermeable container. Preferably the inlet is formed by an aperture in the side wall of the water impermeable container. The aperture may be connected to a pipe, such as a standard pipe for storm water collection that may already be positioned in the area. Preferably the inlet has an opening with a diameter in the range of 70 mm to 160 mm, more preferably 110 mm to 125 mm.

Thus water enters the plant growth system via the inlet, and passes directly in the first void space. Water in the first void space then passes into the layer of buffer material via the first side surface. As described above, the inventors have discovered that this arrangement allows for optimal buffering capacity and water retention of the MMVF buffer layer.

The plant growth system according to the present invention comprises a plant growth substrate layer, positioned above the layer of buffer material and in fluid communication with the layer of buffer material.

The plant growth substrate layer may be made from any material suitable for growing plants. The plant growth substrate layer preferably comprises soil, man-made vitreous fibres, peat, wood chips, vermiculite, perlite, sand, coco fibres or a combination thereof.

Preferably the plant growth substrate layer has a height of 10 cm to 200 cm. Preferably the height is in the range of 10 cm to 60 cm for growing plants and 60 cm to 200 cm for growing trees.

The plant growth substrate layer is in fluid communication with the layer of buffer material below. This means water can move upwards in the buffer layer, by capillary action, to the plant growth substrate layer above. The invention is therefore a passive irrigation system which retains storm water in the layer of buffer material, making the water available to the plant growth substrate layer when the plants/trees need it.

The plant growth system according to the present invention may further comprise a water-permeable layer between the layer of buffer material and the plant growth substrate layer. However, this is not an essential requirement. The benefit of the water-impermeable layer is that it can prevent the plant growth substrate layer, which may comprise small particles such as soil, from blocking the pores of the MMVF buffer layer. This ensures the MMVF buffer layer can hold the maximum amount of water in its open pore structure.

Preferably the water-permeable layer is formed of a geotextile. The term water-permeable has its normal meaning in the art, thus the layer allows water to pass from the layer of buffer material to the plant growth substrate layer.

Preferably, the plant growth system according to the invention comprises an inlet overflow. The inlet overflow is preferably positioned above the inlet and preferably at the top of the first void space. Thus, once the layer of buffer material is fully saturated, excess water can flow out of the first void space, through the inlet overflow. Preferably the inlet overflow is positioned higher than the top surface layer of buffer material, to ensure that water only exits via the inlet overflow once the MMVF buffer layer is fully saturated.

As mentioned above, it is preferable that the plant growth system according to the present invention further comprises a second void space, wherein the second void space is in fluid communication with the second side surface of the layer of buffer material. The second void space is within the water impermeable container. By this, it is meant that a second void space is positioned within the internal volume of the water impermeable container, created by the base and side walls. It is preferred that water entering the first void space through the inlet passes through the layer of buffer material before it is able to enter the second void space.

The second void space is in fluid communication with the second side surface of the layer of buffer material. By this, it is meant that fluid, such as storm water, present in the buffer material can move into the second void space through the second side surface of the buffer material.

The second void space is an empty space comprised within the internal volume of the water-impermeable container. Preferably, the second void space is formed between a side wall of the water impermeable container and the second side surface of the layer of buffer material. The base of the water impermeable container forms the base of the second void space. The second void space is essentially a gap between a side wall of the water impermeable container and the second side surface of the layer of buffer material. The second void space provides means for storm water to exit the buffer material.

The second void space may comprise an open structure, such as a crate, to maintain the void space. Preferably, the second void space comprises an open plastic crate. The void space may also comprise gravel—this naturally comprise gaps between the gravel particles, which acts as a void space. The purpose of the open structure is to ensure that the void space between the side wall of the water impermeable container and the second side surface of the layer of buffer material is maintained during use of the plant growth system i.e. to prevent the layer of buffer material from moving during use such that the void space is reduced.

Preferably, the plant growth system comprises a water impermeable overflow wall within the water impermeable container. The water impermeable overflow wall is positioned in direct contact with the second side surface of the layer of buffer material. The water impermeable overflow wall is in direct contact with at least 20% of the surface area of the second side surface, more preferably at least 30%, more preferably at least 40%, more preferably at least 50% of the surface area of the second side surface. Preferably the water impermeable overflow wall extends from the base of the water impermeable container up along 40 to 95% of the height of the second side surface. Preferably 60 to 90% of the height of the second side surface, most preferably 65 to 80%. The water impermeable overflow wall does not extend along the full surface area of the second surface of the buffer material. Preferably it comprises an opening or gap through which water can pass from the buffer material into the second void space. Preferably the opening or gap is positioned at the top of the second surface of the buffer material. This ensures that the buffer material can retain the maximum amount of water before excess water exits.

The water impermeable overflow wall thus forms a barrier between at least part of second side surface of the buffer material and the second void space. This ensures that the buffer material can fill up with water to its maximum extent but still allow for excess water to drain into the second void space, through the part of the second side surface that is not in direct contact with the water impermeable overflow wall. The part of the second side surface that is not in direct contact with the water impermeable overflow wall is the part of the second side surface that is in fluid communication with the second void space.

The water impermeable overflow wall may be formed of any suitable material. Preferably, the water impermeable container is formed of foil, hydrated clay, plastic, corrugated plastic, high density mineral wool or a combination thereof.

Preferably, the plant growth system further comprises an outlet for excess water to leave the layer of buffer material, wherein the outlet is in fluid communication with the second void space. The outlet is preferably one of the principle routes through which storm water can exit the water impermeable container. Preferably the outlet is formed by an aperture in the side wall of the water impermeable container. The aperture may be connected to a pipe, such as a standard pipe for storm water disposal that may already be positioned in the area. Preferably the outlet has an opening with a diameter in the range of 70 mm to 160 mm, more preferably 110 mm to 125 mm.

Preferably the outlet is positioned in a side wall of the water impermeable container that is directly opposition the side wall of the water impermeable container that comprises the inlet. This ensures that the maximum amount of water can be retained in the buffer layer. For the avoidance of doubt, it is preferable that water entering the first void space through the inlet must pass through the layer of buffer material before it is able to enter the second void space before it passes through the outlet. This ensures that water leaving the plant growth system via the outlet, has passed through the buffer layer, meaning the water is substantially free of particulate matter. This is beneficial if the outlet is connected to further storm water collection or treatment systems and water should be free from particulate matter, and other detritus and impurities, when it exits the plant growth system.

Preferably the layer of buffer material comprises an air vent configured to allow air to pass out of the layer of buffer material as water enters the layer of buffer material. Preferably the air vent is a conduit that extends from the buffer material, through the plant growth substrate layer, to the open environment. It thus allows air to be pushed out of the buffer material as storm water enters.

Alternatively, or additionally, the second void space may comprise an air vent configured to allow air to pass out of the layer of buffer material as water enters the layer of buffer material. Preferably the air vent is a conduit that extends from the second void space, through the plant growth substrate layer, to the open environment.

Preferably the conduit is a pipe or tube, an advantage of a pipe is that it is hollow and can therefore freely transport air from the buffer material or the second void space. Further, the wall of the pipe prevents debris from the plant growth substrate layer entering the pipe.

In use, the plant growth system of the invention is preferably at least partially buried underground. Preferably the water impermeable container is positioned entirely underground. Preferably the plant growth substrate layer is positioned partially underground or above ground, such that the top surface of the plant growth substrate is above ground. This ensures that the plants are at ground level but the water impermeable container and the layer of buffer material are underground. This means that the inlet and outlet of the water impermeable container can be connected to storm water collection systems underground (i.e. existing pipes).

An embodiment of the invention is shown in FIG. 1 and FIG. 2.

FIG. 1 shows a plant growth system (1) according to claim 1. The system comprises a water impermeable container (2) having an internal volume. The internal volume of the water impermeable container (2) contains a layer of buffer material (3) and a first void space (4). The buffer material (3) comprises man-made vitreous fibres (MMVF) bonded with a cured binder composition. Water is able to enter the water impermeable container via an inlet (5). Water passes through the inlet (5) into the first void space (4) and then into the buffer material (3). In this way, the inlet (5) is in fluid communication with the first void space (4) which is in fluid communication with the buffer layer (3).

Positioned above the buffer material (3) is the plant growth layer (6). This contains plants and/or trees. Water from the buffer layer (3) moves up into the plant growth layer (6). The buffer layer (3) has a first side surface, a second side surface and a bottom surface and the bottom surface of the buffer material (3) in direct contact with the base of the water impermeable container (2). This ensures that capillary forces move water up through the buffer material (3), ultimately to the plant growth layer (6).

FIG. 1 shows a water overflow (7) positioned above the inlet (5) and in fluid communication with the first void space (4). This provides one means for excess rainwater to leave the system, should the buffer layer (3) and first void space (4) become fully saturated. Excess water can also leave via the outlet (10).

The plant growth system (1) according to FIG. 1 also comprises a second void space (8) and an outlet (10). The second void space (8) is in fluid communication with the second side surface of the buffer material (3) and with the outlet (10).

Furthermore, the system comprises a water impermeable overflow wall (9) positioned in direct contact with the second side surface of the buffer material (3). The water impermeable overflow wall (9) extends from the base of the water impermeable container (3) up along ˜75% of the height of the second side surface.

FIG. 2 further illustrates a plant growth system (1) according to claim 1 of the invention. In addition to the features explained above for FIG. 1, FIG. 2 also shows a water-permeable layer (11) between the layer of buffer material (3) and the plant growth substrate layer (6). Furthermore, FIG. 2 shows an air vent (12) configured to allow air to pass out of the layer of buffer material as water enters the layer of buffer material. The air vents (12) may be positioned in the layer of buffer material and/or, when present, the second void space.

In a second aspect of the invention, there is provided a method of irrigating a plant, comprising the steps of:
providing a plant growth system as described herein;
positioning at least one plant in the plant growth substrate layer;
allowing storm water to enter the layer of buffer material via the inlet and first void space;
allowing the storm water to pass into the plant growth substrate layer by capillary action.

In this aspect, the plant growth system is provided in such a way that storm water entering the layer of buffer material via the inlet and first void space is able to pass into the plant growth substrate layer by capillary action. The plant growth system may have any of the preferred features described above in detail.

Storm water may enter the inlet of plant growth system via any known method. For example, the inlet may be connected to a conduit connected to a gutter system. In this way, storm water is collected and channelled to the inlet of the plant growth system. The storm water then passes into the first void space from the inlet. Once the storm water is in the first void space, it then passes into the buffer material via the first side surface. Due to capillary action, water in the buffer material is channelled up towards the plant growth substrate above. In addition, any excess rain water in the plant growth substrate may enter the buffer material.

In a third aspect of the invention, there is provided a method of installing a plant growth system, comprising positioning at least one plant growth system described herein in the ground.

The plant growth substrate can have any of the preferred features described above in detail.

Preferably the plant growth system is installed such that the water impermeable container is entirely underground. Preferably the plant growth substrate layer is positioned partially underground or above ground, such that the top surface of the plant growth substrate is above ground. This ensures that the plants are at ground level but the water impermeable container and the layer of buffer material are underground. Preferably the inlet is connected to storm water collection systems underground. Preferably the outlet is connected to a storm water disposal system underground (i.e. a sewer network) or a storm water collection point (i.e. a storage tank).

### EXAMPLES

### Example 1: Calculation of Yearly Water Usage

Two plant growth systems, one according to the invention and one comparative, are compared for water usage over one year. The system according to the invention has an MMVF buffer layer of 15 cm in height and a density of 160 kg/m³. The comparative system does not have a buffer layer.

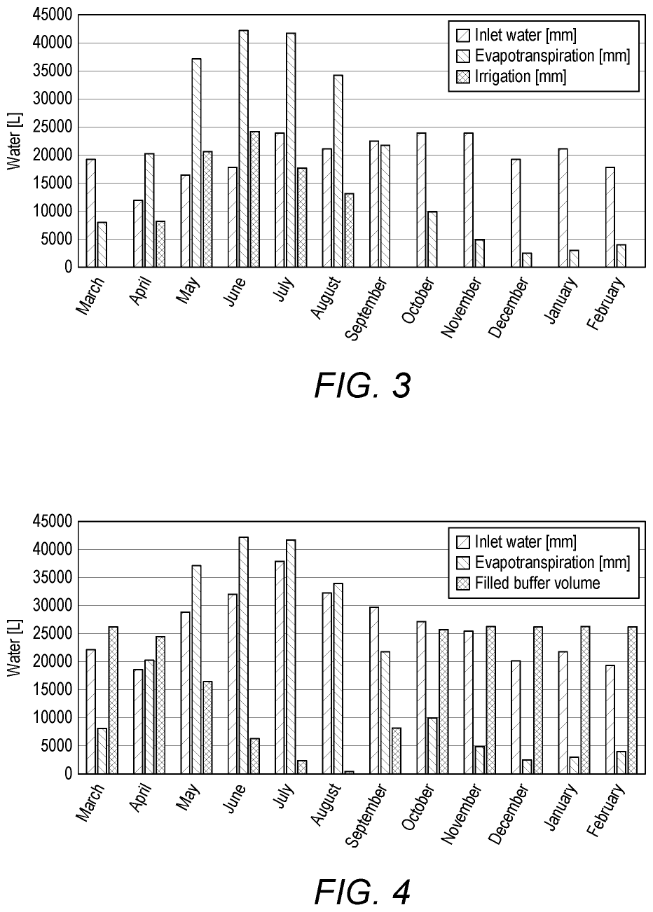

The calculations of water available for plants during the year are shown in FIGS. 3 (comparative system) and 4 (invention). As can be seen from FIG. 3, the comparative system without a MMVF buffer layer cannot take in as much rain water (i.e. inlet water) and so irrigation will be required. In FIG. 4, the system according to the invention will not require any irrigation as it is able to store rain water in the MMVF buffer layer, and this is used by the plants at a later stage throughout the year. The system according to the invention therefore reduces (or eliminates) the requirement for active irrigation, and instead uses rain water.

### Example 2: Water Absorption Test

The following methods for wetting MMVF buffer material were investigated:
1: The MMVF buffer material was positioned in a container with water, so that it is partly submerged.
2: The MMVF buffer material was positioned in a container with water, so that it is partly submerged. In addition, a sand/soil mixture was positioned on top of the MMVF buffer.
3: The MMVF buffer material was positioned in a container with water, so that it is partly submerged. In addition, moist sand was positioned at the bottom of the container, such that the MMVF material was positioned on top of the sand.

The wetting of the buffer material comprising MMVF was done from the top side under a water tap (at high flow speed, which is comparable with an inlet pipe of collected water from street/roof) and using a pipette (low flow speed, which is comparable with actual rain). Different densities were used:
WM 2003:75 kg/m3
WM 2005:120 kg/m3
WM 2009:200 kg/m3

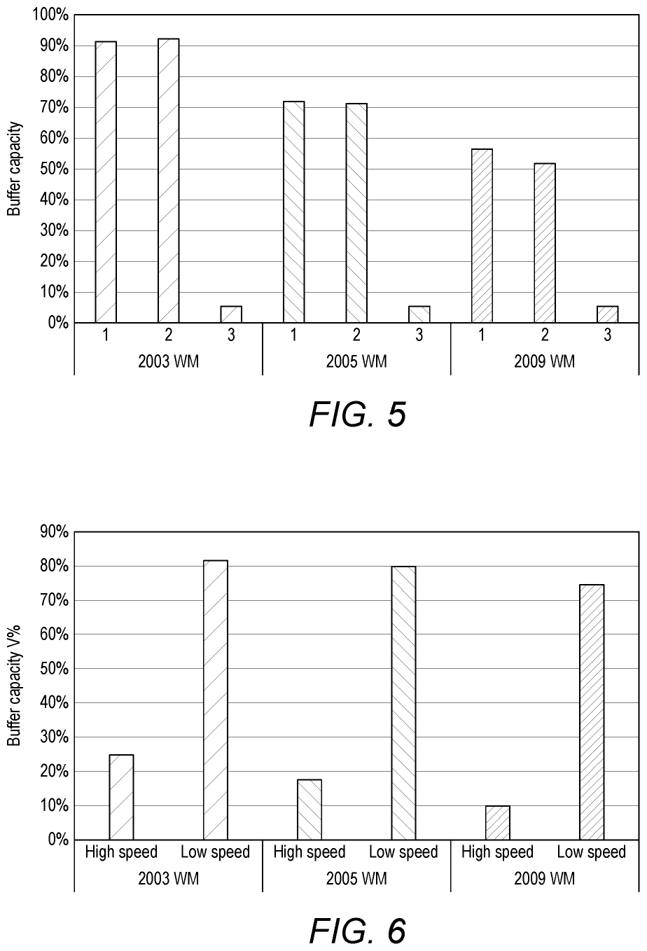

The results are shown in FIGS. 5 and 6.

From FIG. 5, it can be seen that the absorption of water (i.e. buffer capacity) is high for all densities tested using methods 1 and 2. The lower the density, the higher the buffer capacity. However, when sand was positioned under the MMVF buffer, the buffer capacity was low i.e. less than 10%. This demonstrates that it is important to have a water-impermeable container underneath and in direct contact with the buffer layer.

FIG. 6 shows the results of high speed wetting versus low speed wetting. For a density of 75 kg/m³, at high flow speed the water absorption was 25% before the MMVF starts to drain water at the bottom. At low flow speed the water absorption was 80%. Similar results were seen for densities of 120 kg/m³ and 200 kg/m³ i.e. the buffer capacity was higher when low speed is used. This demonstrates that the use of a void space, as claimed in the present invention, improves the buffer capacity as water can enter the MMVF buffer layer more slowly.

### Example 3: Maximum Buffer Capacity

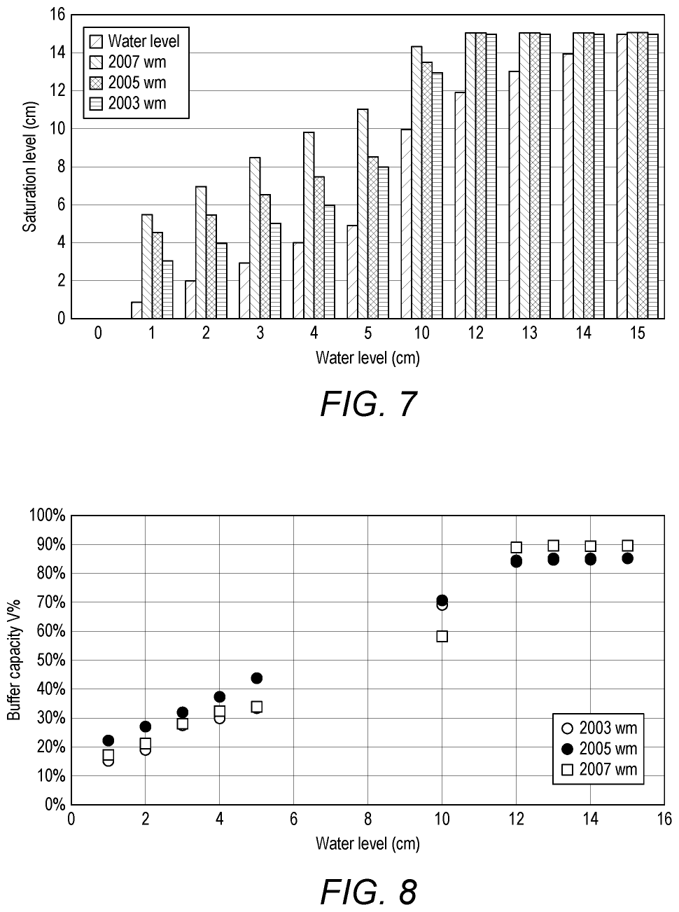

Buffer material of 15 cm in height comprising MMVF with differing densities were tested by wetting in a container with different water levels (1 to 15—see FIGS. 7 and 8). The densities were as follows:
WM 2003:75 kg/m3
WM 2005:120 kg/m3
WM 2007:160 kg/m3

The results are shown in FIGS. 7 and 8.

It can be seen from FIG. 7 that, with a water level of 10 cm the capillary rise of WM 2007 was 14.3 cm and 13.5 cm and 13 cm for WM 2005 and WM 2003 respectively.

It can be seen from FIG. 8 that at a water level of 12 cm, the maximum buffer capacity was reached for MMVF: 89% for WM 2007, 86% for WM 2005 and 85% for WM 2003.

From FIGS. 7 and 8 it can be seen that a higher density has a higher capillary rise and therefore more buffering capacity can be created in the system. It can also be seen that the optimum height for an overflow for the system with MMVF buffer material having a height of 15 cm is 10 to 12 cm (form FIG. 8).

### Example 4: Water Release Test

Three different types of buffer material comprising MMVF were tested. These substrates were as follows:
WM 2003:75 kg/m3
WM 2005:120 kg/m3
WM 2007:160 kg/m3

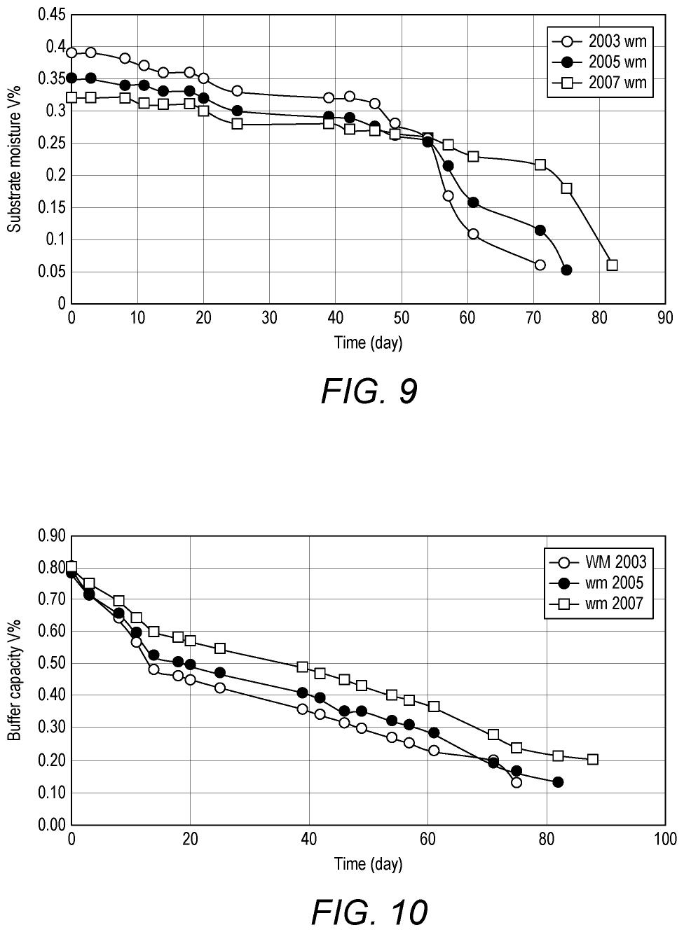

A layer of material was positioned above the buffer material. The results are shown in FIGS. 9 and 10. FIG. 9 shows the substrate moisture content V % i.e. water release to the layer above. FIG. 10 shows the buffer capacity V %.

FIG. 9 shows that the water release from the MMVF buffer layer to the substrate above is faster with a lower density MMVF layer compared to a higher density. For example, after 75 days, the moisture content reached the minimum level of 6% for WM 2003, which was 5% after 82 days for WM 2005 and 89 days for WM 2007.

FIG. 10 show that, when the MMVF buffer layer is almost dried out, a higher density (WM 2007) still buffers some water (20%), where lower densities (WM 2003 and WM 2005) are almost dried out (10%). Therefore, a higher density of MMVF provides water to the layer above over a longer period.

### Example 5: Fibre-Water Interaction

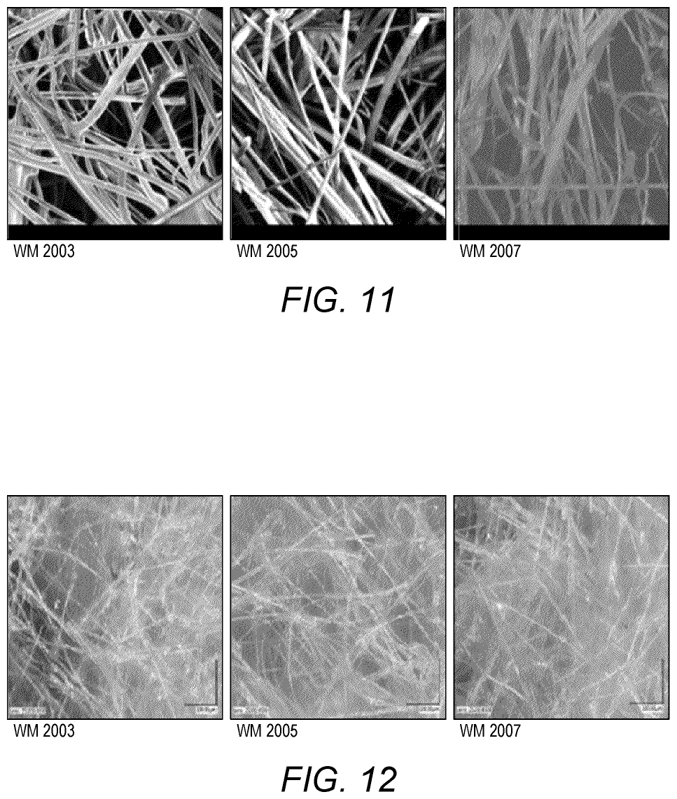

SEM photos have been made with a magnification of 1500 times with different stone wool densities; WM 2003 (75 kg/m3), WM 2005 (120 kg/m3) and WM 2007 (160 kg/m3). The images are shown in FIGS. 11 and 12.

It can be seen that the distance between the stone wool fibres of lower densities is larger compared to higher densities with an average distance respectively of 12.9 μm, 4.63 μm and 2.32 μm. This results in a faster water absorption and water release to substrate medium.

Also the contact angles between the fibres are sharper at higher densities than lower densities, which results in a higher capillary rise.

### Example 6: Substrate Moisture Level

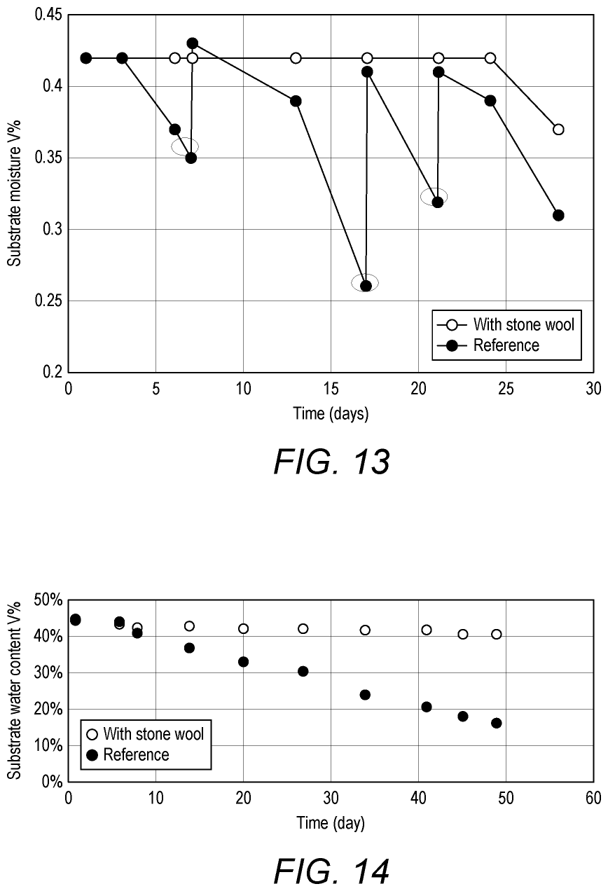

Two plant growth systems, one according to the invention (with MMVF i.e. stone wool) and one comparative (without MMVF) were analysed for water usage over 30 days. The results are shown in FIGS. 13 and 14. As can be seen from FIG. 13, the system without a MMVF buffer layer (reference) required additional irrigation and even then, the moisture content varied greatly. By contrast, the system according to the invention maintained a very consistent moisture content and did not require as many irrigation moments. The system using MMVF remained constant for 25 days without the addition of extra water. Without MMVF (reference) an amount of 5 L in 25 days was added. Using MMVF a stable moisture content of the substrate can be reached for at least 4 weeks and saves 20 liters of water per m² per month.

The following are non-limited numbered embodiments of the invention.

Numbered embodiment 1. A plant growth system (1) comprising:
a water impermeable container (2) having a base and side walls, wherein the water impermeable container comprises within:
(i) a layer of buffer material (3) for absorbing storm water and;
(ii) a first void space (4);
wherein the layer of buffer material has a first side surface, a second side surface and a bottom surface, wherein the bottom surface of the layer of buffer material is in direct contact with the base of the water impermeable container and wherein the buffer material comprises man-made vitreous fibres (MMVF) bonded with a cured binder composition wherein the first void space is in fluid communication with the first side surface of the layer of buffer material;
an inlet (5) for water to enter the first void space of the water impermeable container;
a plant growth substrate layer (6), positioned above the layer of buffer material and in fluid communication with the layer of buffer material.

Numbered embodiment 2. The plant growth system according to numbered embodiment 1, wherein the first void space is in fluid communication with at least 25% of the surface area of the first side surface of the layer of buffer material, preferably at least 50%, more preferably at least 60% of the surface area of the first side surface of the layer of buffer material.

Numbered embodiment 3. The plant growth system according to numbered embodiment 1 or 2, wherein the layer of buffer material has a density in the range of 70 to 200 kg/m³ preferably 100 to 160 kg/m³.

Numbered embodiment 4. The plant growth system according to any preceding numbered embodiment, wherein the layer of buffer material is hydrophilic.

Numbered embodiment 5. The plant growth system according to numbered embodiment 4, wherein the layer of buffer material has a contact angle with water of less than 90° and/or a hydraulic conductivity of 5 m/day to 300 m/day, preferably 50 m/day to 200 m/day.

Numbered embodiment 6. The plant growth system according to any preceding numbered embodiment, wherein the layer of buffer material comprises MMVF having a geometric fibre diameter of 1.5 to 10 microns, preferably 2 to 8 microns, more preferably 2 to 5 microns.

Numbered embodiment 7. The plant growth system according to any preceding numbered embodiment, wherein the layer of buffer material comprises coherent MMVF bonded with a cured binder composition, preferably a slab of MMVF, and/or granulate MMVF bonded with a cured binder composition.

Numbered embodiment 8. The plant growth system according to any preceding numbered embodiment, wherein the predominant fibre orientation of the layer of buffer material is vertical or horizontal.

Numbered embodiment 9. The plant growth system according to any preceding numbered embodiment, wherein the layer of buffer material has a height in the range of 5 cm to 50 cm, preferably 10 cm to 20 cm.

Numbered embodiment 10. The plant growth system according to any preceding numbered embodiment, further comprising a storm water overflow (7) positioned above the inlet and in fluid communication with the void space.

Numbered embodiment 11. The plant growth system according to any preceding numbered embodiment, further comprising a second void space (8), wherein the second void space is in fluid communication with the second side surface of the layer of buffer material.

Numbered embodiment 12. The plant growth system according to any preceding numbered embodiment, further comprising a water impermeable overflow wall (9) positioned in direct contact with the second side surface, wherein the water impermeable overflow wall extends from the base of the water impermeable container up along 40 to 95% of the height of the second side surface, preferably 60 to 90%, most preferably 65 to 80% of the height of the second side surface.

Numbered embodiment 13. The plant growth system according to any preceding numbered embodiment, further comprising an outlet (10) for excess water to leave the layer of buffer material, wherein the outlet is in fluid communication with the second void space.

Numbered embodiment 14. The plant growth system according to any preceding numbered embodiment, further comprising a water-permeable layer (11) between the layer of buffer material and the plant growth substrate layer.

Numbered embodiment 15. The plant growth system according to any preceding numbered embodiment, wherein the layer of buffer material or the second void space comprises an air vent (12) configured to allow air to pass out of the layer of buffer material as water enters the layer of buffer material.

Numbered embodiment 16. The plant growth system according to any preceding numbered embodiment, wherein water impermeable container is formed of foil, hydrated clay, plastic, corrugated plastic, high density mineral wool or a combination thereof.

Numbered embodiment 17. The plant growth system according to any preceding numbered embodiment, wherein the plant growth substrate layer comprises soil, man-made vitreous fibres, peat, wood chip, vermiculite, perlite, sand, coco fibres or a combination thereof.

Numbered embodiment 18. A method of irrigating a plant, comprising the steps of:
providing a plant growth system according to any preceding numbered embodiment;
positioning at least one plant in the plant growth substrate layer;
allowing storm water to enter the layer of buffer material via the inlet and first void space;
allowing the storm water to pass into the plant growth substrate layer by capillary action.

Numbered embodiment 19. A method of installing a plant growth system, comprising positioning at least one plant growth system according to any of numbered embodiments 1 to 17 in the ground.

1. A plant growth system comprising:
a water impermeable container having a base and side walls, wherein the water impermeable container comprises within:
(i) a layer of buffer material for absorbing storm water and;
(ii) a first void space;
wherein the layer of buffer material has a first side surface, a second side surface and a bottom surface, wherein the bottom surface of the layer of buffer material is in direct contact with the base of the water impermeable container and wherein the buffer material comprises man-made vitreous fibres (MMVF) bonded with a cured binder composition; and
wherein the first void space is in fluid communication with the first side surface of the layer of buffer material;
an inlet for water to enter the first void space of the water impermeable container; and
a plant growth substrate layer, positioned above the layer of buffer material and in fluid communication with the layer of buffer material.

2. The plant growth system according to claim 1, further comprising a second void space in fluid communication with the second side surface of the layer of buffer material and an outlet for excess water to leave the layer of buffer material, wherein the first void space and second void space are configured so that water entering the first void space through the inlet must pass through the layer of buffer material before it is able to enter the second void space.

3. The plant growth system according to claim 1, comprising
(a) a removable MMVF filter that forms the first side surface of the layer of buffer material; and/or
(b) a removable MMVF filter in the inlet.

4. The plant growth system according to claim 1, wherein the layer of buffer material occupies at least 50% of the volume in the water impermeable container under the plant growth substrate layer.

5. The plant growth system according to claim 1, wherein at least 50% of the area of the bottom surface of the plant growth substrate layer is in fluid communication with the layer of buffer material.

6. The plant growth system according to claim 1, wherein the first void space is in fluid communication with at least 25% of the surface area of the first side surface of the layer of buffer material.

7. The plant growth system according to claim 1, wherein the layer of buffer material has a density in the range of 70 to 200 kg/m³.

8. The plant growth system according to claim 1, wherein the layer of buffer material is hydrophilic.

9. The plant growth system according to claim 8, wherein the layer of buffer material has a contact angle with water of less than 90° and/or a hydraulic conductivity of 5 m/day to 300 m/day.

10. The plant growth system according to claim 1, wherein the layer of buffer material comprises MMVF having a geometric fibre diameter of 1.5 to 10 microns.

11. The plant growth system according to claim 1, wherein the layer of buffer material comprises coherent MMVF bonded with a cured binder composition.

12. The plant growth system according to claim 1, wherein the predominant fibre orientation of the layer of buffer material is vertical or horizontal with respect to the base of the water impermeable container.

13. The plant growth system according to claim 1, wherein the layer of buffer material has a height in the range of 5 cm to 50 cm.

14. The plant growth system according to claim 1, further comprising a storm water overflow positioned above the inlet and in fluid communication with the void space.

15. The plant growth system according to claim 1, further comprising a water impermeable overflow wall positioned in direct contact with the second side surface, wherein the water impermeable overflow wall extends from the base of the water impermeable container up along 40 to 95% of the height of the second side surface.

16. The plant growth system according to claim 1, further comprising a water-permeable layer between the layer of buffer material and the plant growth substrate layer.

17. The plant growth system according to claim 1, wherein the layer of buffer material and/or, when present, the second void space comprises an air vent configured to allow air to pass out of the layer of buffer material as water enters the layer of buffer material.

18. The plant growth system according to claim 1, wherein the water impermeable container is formed of foil, hydrated clay, plastic, corrugated plastic, high density mineral wool or a combination thereof.

19. The plant growth system according to claim 1, wherein the plant growth substrate layer comprises soil, man-made vitreous fibres, peat, wood chip, vermiculite, perlite, sand, coco fibres or a combination thereof.

20. A method of irrigating a plant, comprising the steps of:
providing a plant growth system according to claim 1, and
positioning at least one plant in the plant growth substrate layer,
such that storm water entering the layer of buffer material via the inlet and first void space is able to pass into the plant growth substrate layer by capillary action.

21. A method of installing a plant growth system, comprising positioning at least one plant growth system according to claim 1 in the ground.
